(19) United States
(12) Patent Application Publication
(10) Pub. No.: US 2019/0188756 A1
(43) Pub. Date: Jun. 20, 2019

(54) METHODS AND DEVICES FOR DETERMINING DISTRACTION LEVEL OF USERS TO SELECT TARGETED ADVERTISEMENTS

(71) Applicant: AT&T Intellectual Property I, L.P., Atlanta, GA (US)

(72) Inventors: Nigel Bradley, McDonough, GA (US); Timothy Innes, Atlanta, GA (US); James Pratt, Round Rock, TX (US); Eric Zavesky, Austin, TX (US)

(73) Assignee: AT&T Intellectual Property I, L.P., Atlanta, GA (US)

(21) Appl. No.: 15/843,889

(22) Filed: Dec. 15, 2017

(51) Int. Cl. G06Q 30/02; H04N 21/442; H04N 21/422; G06K 9/00

(52) U.S. Cl. CPC G06Q 30/0269; H04N 21/44218; G06K 9/00335; G06K 9/00221; H04N 21/42202

(57) ABSTRACT

Aspects of the subject disclosure may include, for example, embodiments such as determining a media device is in operation and identifying a user is in proximity to the media device. Further embodiments include determining a distraction level for the user in response to determining a first application in use on the media device. Additional embodiments include identifying a marketing profile for the user. Also, embodiments include selecting a target advertisement according to the distraction level and the marketing profile, and providing the target advertisement to be presented on the media device. Other embodiments are disclosed.

### FIELD OF THE DISCLOSURE

The subject disclosure relates to methods and devices for determining distraction level of users to select targeted advertisements.

### BACKGROUND

Advertising can be a significant revenue stream for media content providers. Further, a user of media content can view media content on different media devices that can include, but not limited to, a television, a laptop computer, a desktop computer, a tablet computer, wearable device, and a smartphone. In addition, a user can have more than one media device in operation at the same time. Current systems can determine the demographic of the user and can target an advertisement on a media device in operation according to the user's demographic.

### BRIEF DESCRIPTION OF THE DRAWINGS

Reference will now be made to the accompanying drawings, which are not necessarily drawn to scale, and wherein:

FIGS. 1A-1B depicts illustrative embodiments of systems for determining distraction level of users to select targeting advertisements;

FIG. 2 depicts another illustrative embodiment of a system for determining distraction level of users to select targeting advertisements;

FIGS. 3A-3C depict illustrative embodiments of methods used in portions of the system described in FIGS. 1A-1B and FIG. 2;

FIGS. 4-5 depict illustrative embodiments of communication systems that provide media and advertisement services;

FIG. 6 depicts an illustrative embodiment of a web portal for interacting with the communication systems providing media and advertisement services;

FIG. 7 depicts an illustrative embodiment of a communication device; and

FIG. 8 is a diagrammatic representation of a machine in the form of a computer system within which a set of instructions, when executed, may cause the machine to perform any one or more of the methods described herein.

### DETAILED DESCRIPTION

The subject disclosure describes, among other things, illustrative embodiments that include determining a media device is in operation and identifying a user is in proximity to the media device. Further embodiments include determining a distraction level for the user in response to determining a first application in use on the media device. Additional embodiments include identifying a marketing profile for the user. Also, embodiments include selecting a target advertisement according to the distraction level and the marketing profile, and providing the target advertisement to be presented on the media device. Other embodiments are described in the subject disclosure.

One or more aspects of the subject disclosure include a device. The device can comprise a processing system including a processor, and a memory that stores executable instructions that, when executed by the processing system, facilitate performance of operations. The operations can include determining a media device is in operation and identifying a user is in proximity to the media device. Further operations can include determining a distraction level for the user in response to determining a first application in use on the media device. Additional operations can include identifying a marketing profile for the user. Also, operations can include selecting a target advertisement according to the distraction level and the marketing profile, and providing the target advertisement to be presented on the media device.

One or more aspects of the subject disclosure include a machine-readable medium, comprising executable instructions that, when executed by a processing system including a processor, facilitate performance of operations. Operations can include determining a first media device is in operation and identifying a plurality of users is in proximity to the first media device. Further operations can include determining a first distraction level for a first group of users in response to determining a first application in use on the first media device. The plurality of users comprise the first group of users. Additional operations can include determining a second distraction level for a second group of users in response to determining the second group of users viewing a second media device. The plurality of users comprise the second group of users. Also, the operations can include identifying a marketing profile for each user the plurality of users. Further operations can include selecting a first target advertisement according to the first distraction level and a first marketing profile for each of the first group of users. Additional operations can include selecting a second target advertisement according to the second distraction level and a second marketing profile for each of the second group of users. Also, operations can include providing the first target advertisement to be presented on the first media device, and providing the second target advertisement to be presented on the second media device.

One or more aspects of the subject disclosure include a method. The method can include determining, by a processing system including a processor, a first media device is in operation. Further, the method can include identifying, by the processing system, a plurality of users is in proximity to the first media device. In addition, the method can include determining, by the processing system, a marketing profile for each user the plurality of users. Also, the method can include selecting, by the processing system, a first target advertisement according to a first marketing profile for each of a first group of users and a second marketing profile for each of a second group of users, wherein the plurality of users comprise the first group of users and the second group of users. The first target advertisement is selected to attract attention of each of the first group of users. The first target advertisement is selected to distract attention of each of the second group of users. Further, the method can include providing, by the processing system, the first target advertisement to be presented on the first media device. In addition, the method can include identifying, by the processing system, the second group of users are in proximity to a second media device. Also, the method can include selecting, by the processing system, a second target advertisement according to the second marketing profile for each of the second group of users. Further, the method can include providing, by the processing system, the second target advertisement to be presented on the second media device.

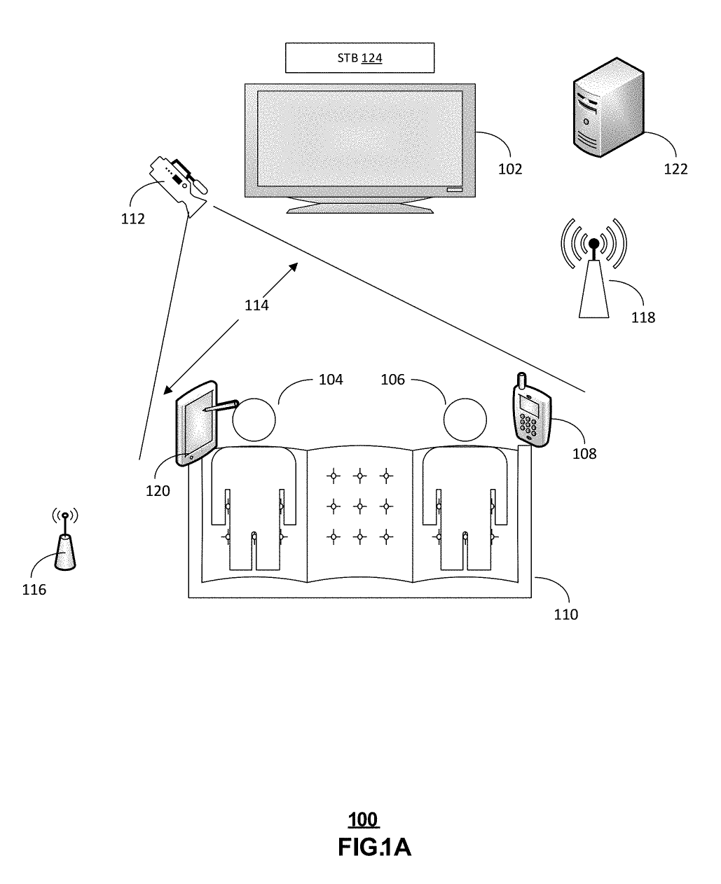

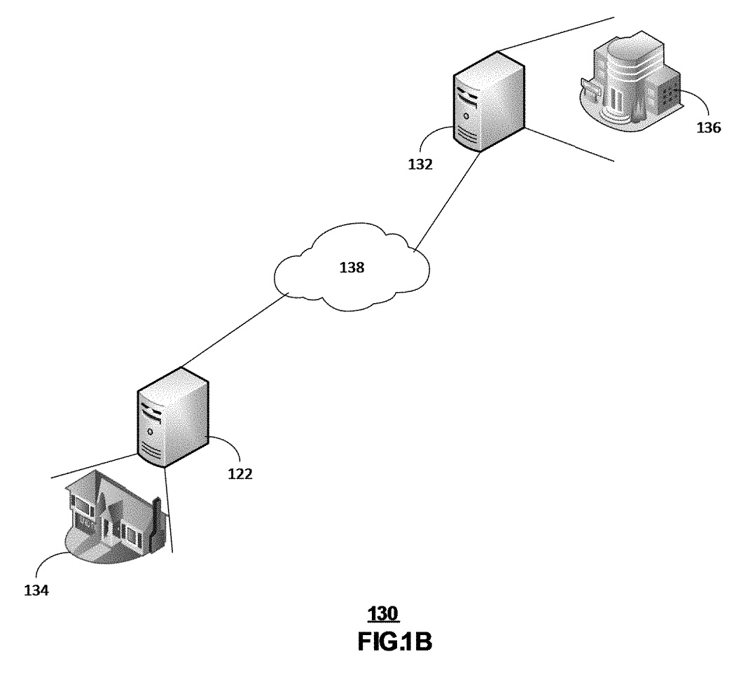

FIGS. 1A-1B depicts illustrative embodiments of systems for determining distraction level of users to select targeting advertisement. Referring to FIG. 1A, in one or more embodiments, the system 100 can include one or more media devices such as television 102, set top box or media processor 124, smartphone, 108, and tablet computer 120 associated with users 104, 106. The media processor 124 can be associated with any of the one or more of the television 102, smartphone 108, and tablet computer 120. Other media devices can be used in system 100 that can include, but not limited to, laptop computers, desktop computers, wearable devices, and other computing devices. Users 104, 106 can be sitting on a sofa 110 within a viewing area 114. A camera associated with one of more of the media devices (i.e. television 102) can be oriented toward the viewing area 114. Further, the system 100 can include environment sensors 116 that can include, but not limited to, sensors that detect ambient noise in the viewing area 114, ambient temperature, geographic location, movement within the viewing area 114, ambient humidity, or any other environment sensor. In addition, the system 100 can include a wireless network access point such as a WiFi access point 118 that allows the media devices to access media content or information from the Internet or other information repository. Also, the system 100 can include a gateway device 122 communicatively coupled to the media devices. The gateway device can also be communicative coupled to an advertisement management server or system to gather information regarding the users 104, 106, their use of the media devices, and the sensor information to select target advertisement to be presented on one or more of the media devices. In some embodiments, the gateway device 122 can act as an advertisement management server.

In one or more embodiments, a user 106 may be viewing media content, such as a live sport game broadcast, on the television 102. However, during commercial breaks the user 106 may be viewing content on smartphone 108. System 100 can determine a distraction level of the user 106 during past commercial breaks and select a target advertisement to be presented during the future commercial breaks on television 102 or on smartphone 108.

In one or more embodiments, the user 106 can be determined using biometric identification that includes, but is not limited to, facial recognition, retina scan, fingerprint, voice recognition, walking gait recognition, passcode, etc. In addition, the user 106 can be determined by identifying an active (or in operation) media device within the viewing area 114 and determining the user 106 by identifying a user associated with the identified active media device. The active media device can be identified by determining the device identifier (e.g. international mobile subscriber identity (IMSI)), serial number, media access control (MAC) address, geolocation coordinates, or user login credentials.

In one or more embodiments, the gateway device 122 or an advertisement management server determines that the media device is in operation. In one embodiment, this can be determined by analyzing the information traffic exchanged between the media device and the Internet or media content repository. That is, if there is significant traffic exchanged, then it can indicate the user is actively using the media device. In another embodiments, the camera 112 associated with the media device can capture an image of the viewing area 114 and provide the image to the gateway device 122 and/or advertisement management server to be analyzed using image recognition techniques/technology. Image recognition can reveal that the users 104, 106 are viewing television 102, smartphone 108, and/or tablet computer 120.

In one or more embodiments, the gateway device 122 or advertisement management server can identify the users 104, 106 using biometric analysis or media device identification. In other embodiments, the users 104, 106 can be identified by applying image recognition of the captured image of the viewing area 114. In further embodiments, the user 104, 106 can be identified to be in proximity to a media device in operation. In one embodiment, the gateway device 122 or advertisement management server can analyze traffic between the smartphone 108 or tablet computer to determine that either is in operation and thus the respective user 104, 106 are in proximity to the tablet computer 120 and smartphone 108, respectively. In another embodiment, the television 102 may be in operation, and the captured image of the viewing area 114 can be analyzed using image recognition techniques to determine that users 104, 106 are in proximity to the television 102. In some embodiments, with television 102 in operation, the geolocation of the tablet computer and smartphone relative to the geolocation of the television can determine the users proximity to the television 102 (after determining that the tablet computer 120 and smartphone 108 are active indicating that users 104, 106 are operating tablet computer 102 and smartphone 108, respectively). In a further embodiment, the tablet computer 120 and smartphone 108 are determined to be in use indicating that users 104, 106 are operating them. In additional embodiments, the strength of the signal from each of the tablet computer 120 and smartphone 108 to the WiFi access point 118 can be measured to determine the distance of the tablet computer 102 and smartphone 108 to the WiFi access point 118. With the knowledge of the location of the WiFi access point 118 relative to the television 102, the proximity of user 104, 106 to the television 102 can be determined.

In one or more embodiments, the gateway device 122 or the advertisement management server can determine the distraction level of each user 104, 106 in response to determining an application in use on a media device. An application in use on the television 102 can be a conventional television broadcast using cable or satellite television provider system or a streaming application on the television 102 (i.e. smart television). An application in use on tablet computer 120 or smartphone 108 can be an internet browser, word processing application, media application, etc. In some embodiments, the distraction level can be determined according to the application in use and the type of distraction. For example, if the user 106 is viewing an internet browser on smartphone 108 with a music streaming application in the background, then the user 106 would be distracted by the internet browser from viewing a visual advertisement shown on the music streaming application. In another example, if the user 106 is viewing an internet browser on the smartphone 108 (with no music streaming application running in the background) and the television 102 is showing media content with advertisements, user is visually distracted from the television. An advertisement can be played on the television with audible media content to attract the attention of user 106 from smartphone 108 to television 102.

In one or more embodiments, the gateway device 122 or advertisement management server can gather information from one or more environment sensors to assist in determining the distraction level of user 104, 106. That is, if sensor information is above or below a predetermined threshold (depending on sensor type), a distraction level for a user can be adjusted, accordingly. For example, a noise sensor 116 can detect the ambient noise in the viewing area 114. The noise can be ambient noise due to music in the room (e.g. music playing at a sports bar) or cross talk between users (e.g. conversation among sports bar patrons). If the ambient noise level is less than a predetermined threshold then an audible component for the (environment) distraction level can be adjusted to a higher value or score and an advertisement can include visual media to attract user(s) attention. Further, the environment sensors can detect that whether the viewing area is indoor or outdoor. If the environment sensors includes a temperature sensor and records a room temperature (i.e. within in an upper and lower temperature threshold) then the users can be determined to be indoors. However, if a temperature sensor indicates an ambient temperature of the viewing area 114 to be below a lower temperature threshold or above an upper temperature threshold, then it can be determined the viewing area 114 is outdoors. Different targeted advertisements can be selected according to whether the viewing area 114 is indoors or outdoors. Advertisements with a significant audible media component may not be conducive to be shown in an outdoors viewing area as the sound of the advertisement would not be carried to the user 104, 106. In other embodiments, the user 104, 106 may carry portable computing devices such as smartphones, tablet computers, wearable devices, etc. that provide periodic location of the portable computing device to determine whether the portable computing device is in motion indicating that the user 104, 106 may also be in motion (e.g. walking, running, etc.). If the user 104, 106 is in motion, then an advertisement with a significant audible media component can be selected to attract the attention of the user 104, 104 and advertisement with a significant visual media component is not selected as the user 104, 106 is determined to be distracted from visual media because the user 104, 106 is in motion.

In one or more embodiments, the environment sensors can detect the number of actions the user 104, 106 is performing on a tablet computer 120 or smartphone 108 in a period of time indicating that user 104, 106 is distracted from viewing the television 102. Thus, an advertisement with a significant audible media component can be selected to attract the attention of user 104, 106 from viewing tablet computer 120 or smartphone 108. In other embodiments, an image captured by a camera 112 of the viewing area can be analyzed using image recognition techniques to determine a number of people in the viewing area. If a number of people in the viewing area is above a threshold then user 104, 106 can be distracted by them and advertisement can be selected to be presented on the television 102 that has a significant audible media component to attract the attention of user 104, 106. In further embodiments, the gateway device 122 can determine the internet or data traffic to media devices such as tablet computer 120 and smartphone 108 to determine the number of active devices in the viewing area 114, thereby indicating the users 104, 106 are distracted from the television 102. An advertisement can be selected to be present on the television 102 that has a significant audible component to attract the user 104, 106 from tablet computer 120 and smartphone 108 to television 102.

In one or more embodiments, a user 104, 106 can be identified using biometric analysis or by identifying a device (and determining the user 104, 106 associated with the device). Further, a marketing profile can be identified for the user 104, 106 by the gateway device 122 or advertisement management server. In some embodiments, the gateway device 122 or advertisement management server can access the marketing profile from a user database. The marketing profile indicate the demographics information of the user 104, 106 and the user preferences to discern products and services that may be of interest to the user 104, 106.

In one or more embodiments, the gateway device 122 or advertisement management server determines that a user 106 views the smartphone 108 during commercial break of media content displayed on television 102. Further, the gateway device 122 or advertisement management server determines that user 104 views advertisements displayed on the television 102 during a commercial break. In addition, the gateway device 122 or advertisement management server can select one advertisement to be presented on the television 102 according to the distraction level and marketing profile of each user 104, 106. The advertisement is selected such that it attracts the attention of user 104 and distracts the attention of user 106 facilitating the user 106 to view the smartphone 108 during the presentation of the selected advertisement. Also, the gateway device 122 or advertisement management server can select another advertisement according to distraction level and marketing profile of user 106 and provide the other advertisement to the smartphone 108 to attract the attention of the user 106 during the commercial break.

Referring to FIG. 1B, in one or more embodiments, system 130 can include a gateway device 122 located at a customer premises 134, such a residence or commercial premises, communicatively coupled to an advertisement management server 132 over a communication network 138. The advertisement management server 132 can be located in an office building 135 or any premises operated by a media content provider/distributor or advertisement content provider/distributor. The communication network can comprise portions of the Internet or comprise a proprietary network such as a cable television or satellite television network.

In one or more embodiments, the advertisement management server 132 can receive information from the gateway device 122 such as Internet or data analytics regarding media devices at the customer premises 134. The advertisement management server 132 can determine which of the media devices at the customer premises 134 are active or in operation. In addition, the gateway device 122 can provide a captured image of a viewing area of one more media devices to the advertisement management server 132 to be analyzed using image recognition techniques to determine the number of viewers for a particular media device, or whether any users are distracted or attracted to one or more media devices. Also, the gateway device 122 can provide environment sensor information to the advertisement management server 132 to determine a distraction level for any of the users according to the environment sensor information. Further, the gateway device 122 can provide biometric information regarding the users or device identification information for media devices at the customer premises 134. The advertisement management server 132 can determine the identity of the user according to the biometric information or device information. Further, the advertisement management server 132 can access a marketing profile for a user from a user database within the communication network 138. In addition, the gateway device 122 can provide geolocation information of the media devices to the advertisement management server form which a user relative position to another media device can be determine or whether the user is in motion or stationary.

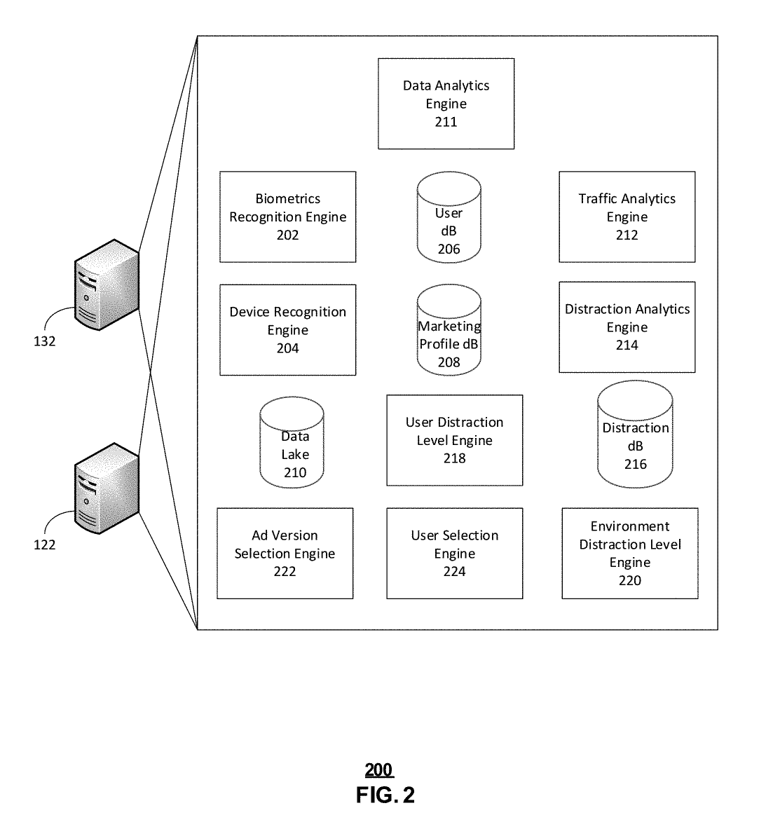

FIG. 2 depicts another illustrative embodiment of a system 200 for determining distraction level of users to select targeting advertisements. In one or more embodiments, the system 200 or portions thereof can incorporated within a gateway device 122 or in an advertisement management server 132. In other embodiments portions of system 200 can be incorporate gateway device 122 while other portions of system 200 can be incorporate in advertisement management server 132.

In one or more embodiments, system 200 can comprise components that include, but not limited to, a biometrics engine 202, a device recognition engine 204, a user database 206, a marketing profile database 208, a data lake database 210, a data analytics engine, a traffic analytics engine 212, a distraction analytics engine 214, a distraction database 216, a user distraction level engine 218, an environment distraction level engine 220, an advertisement selection engine 222 and a user selection engine 224. The components can be implemented by software, hardware or a combination of the gateway device 122 or advertisement management server 132.

In one or more embodiments, the biometrics recognition engine 202 can receive biometric information from one or more media devices and identify a user associated with the biometric information. Further, the biometric information can include images captured by the camera associated or integrated within media devices (e.g. camera integrated into a smartphone, camera integrated into a tablet computer, etc.). The captured images may include images of the face, retina (i.e. retina scan), fingerprint, and/or walking gait of the user. The biometric recognition engine can access corresponding stored images from the user database 206 can use image recognition technique to identify the user. In other embodiments, the biometric information can include voice file (i.e. a file that stores the recorded voice of the user) that is captured by a voice recognition user input device of the media device and provided to the biometric recognition engine 202. Further, the biometric recognition engine 202 can access a corresponding voice file from the user database 206 to identify the user using voice recognition techniques.

In one or more embodiments, the device recognition engine 204 can receive device information from one or more media devices and identify a user associated with each device. Further, the device information can include a device identifier, a device serial number, a MAC address, geolocation coordinates, and user login credentials. The device recognition engine 204 can compare such received information with corresponding information stored in the user database 206 and identify the user associated with each media device. For example, the device recognition engine 204 can receive the geolocation coordinates of a media device and compare the received geolocation coordinates to the stored geolocation coordinates tin the user database 206 to determine whether there is a match. If so, the device recognition engine 204 further accesses the user identity associated with the stored geolocation coordinates to identify the user (e.g. the geolocation coordinates can be resolved into a residential address that is associated with a user).

In one or more embodiments, the data lake database 210 contains a list of media devices and user metadata associated with each media device. Further, the data analytics engine 211 receives the data associated with each media devices from a customer premises. The data analytics engine 211 processes the data to generate user metadata to be stored in the data lake database 210 or build a user marketing profile that is stored in the marketing profile database 210. For example, the data analytics engine 211 determines from the received data that a table computer (i.e. media device) is used only from 9 pm-11 pm most weekday evenings. Such data can be used to generate metadata to indicate device use to be stored in the data lake database 210. Further, the data shows that household items online from various online e-commerce website are purchased during 9 pm-11 pm on weekdays. Such purchasing information is used to build the marketing profile of the user associated with the tablet computer.

In one or more embodiments, the traffic analytics engine 212 receive data traffic information from one or more media device of the customer premises. Further, the traffic analytics engine can discern which media device are active or in operation and the applications each active media device is running as well as the time intervals the application are running For example, the traffic information, after being processed by the traffic analytics engine 212, can indicate that a television is presenting a football game broadcast and that a smartphone in proximity to the television is viewing an Internet browser during commercial breaks of football game broadcast.

In one or more embodiments, the post processing information from the traffic analytics engine 212 can be provided to the distraction analytics engine 214 to determine any distractions according to the traffic analytics. For example, the distraction analytics engine 214 can determine that a user is distracted by a smartphone during the commercial breaks of a football game broadcast.

In one or more embodiments, the post processing information from the distraction analytics engine 214 can be provided to the user distraction level engine 218. Further, the user distraction level engine 218 can access the distraction database 216 and analyze the post processing information from the distraction analytics engine 214 to determine the user distraction level. For example, information from the distraction database 216 can indicate that advertisements with a significant visual media component played during the past commercial break of a football game broadcast did not attract the user from viewing the smartphone. In addition, advertisements with significant auditory dialogue component did not attract the user's attention. However, advertisement with a significant auditory musical component did attract, at times, the user's attention. Thus, the user distraction level engine 218 can determine a user distraction level according to such data. The user distraction level can be a score that is determined by such data.

In one or more embodiments, the user distraction level engine can also be provided the number of media devices within a viewing area of another media device, the communication between media devices within the viewing area (e.g. cross talk), and the number of people within the viewing area (i.e. by determining a number of active media devices in the viewing area or analyzing a captured image of the viewing area to determine the number of people). This information can be used to adjust the user distraction level. For example, if the number of media devices, cross talk, or number of people within the viewing area is above a predetermined threshold (for each) then the user distraction level can be adjusted to a higher score.

In one or more embodiments, the environment level distraction engine 220 can receive environment sensor information to determine the environment distraction level for a user. The environment information can include ambient noise sensor information, temperature sensor information, humidity sensor information, action/movement sensor. The environment level distraction engine 220 can determine an environment distraction level or score based on such data. For example, if it is determined that the viewing area is outdoors, then the environment distraction level may be higher than if the viewing area is indoors because a user may be more distracted by their surroundings. Further, if the user is walking within the viewing area then the user may be more distracted than if they were seated.

In one or more embodiments, the advertisement selection engine 222 selects an advertisement according to both the user distraction level and the environment distraction level. If the user distraction level is below a predetermined threshold and/or the environment distraction level is below another predetermined threshold, then the advertisement is selected that would appeal to a relatively undistracted user. In some embodiments a user distraction level can comprise a visual distraction component and an audible distraction component, and the environment distraction level can also comprise a visual distraction component and an audible distraction component (e.g. the user distraction level and environment distraction level can comprise a multidimensional (two) dimensional score array—[X][Y] such that X is the visual distraction component score and Y is an audible distraction score). If the visual distraction component of both the user distraction level and the environment distraction level is below a predetermined threshold and the audible distraction component score is above another predetermined threshold, then an advertisement can be selected with a significant visual media component to attract the user's attention. Further, if the audible distraction component of both the user distraction level and the environment distraction level is below a predetermined threshold and the visual distraction component score is above another predetermined threshold, then an advertisement can be selected with a significant audible media component to attract the user's attention.

In one or more embodiments, the advertisement selection engine 222 can select a plurality of advertisements, each of which are sent to a different media device on the customer premises, each media device associated with a different user. The user selection engine 224 in conjunction with the advertisement selection engine selects the user for each advertisement and the according advertisement is sent to the media device associated with the user. For example, a user associated with a television but music playing in the viewing area may be presented an advertisement with a significant visual media component to attract the user's attention. As another example, a user associated with the a smartphone that is viewing an Internet browser with a music streaming application running in the background may be presented with an advertisement between songs on the music streaming application with a significant audible media component to attract the user's attention.

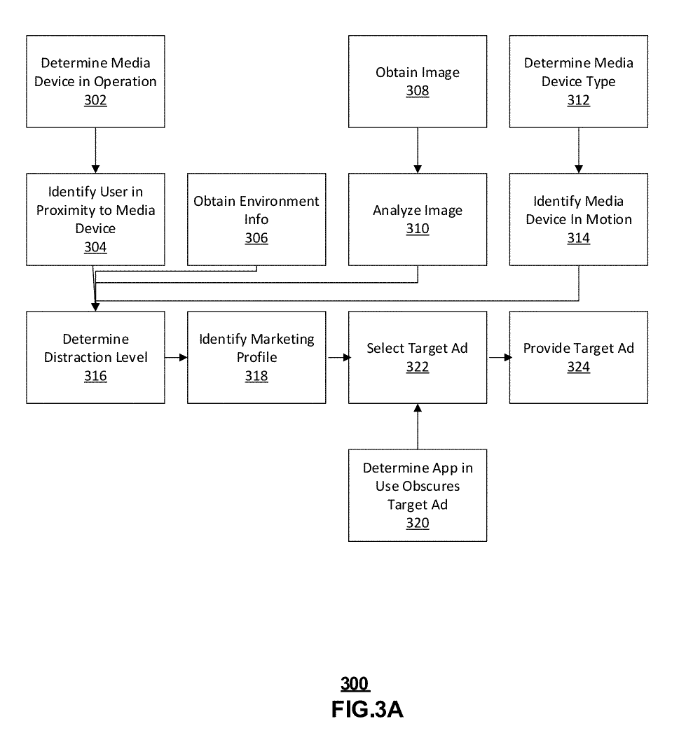

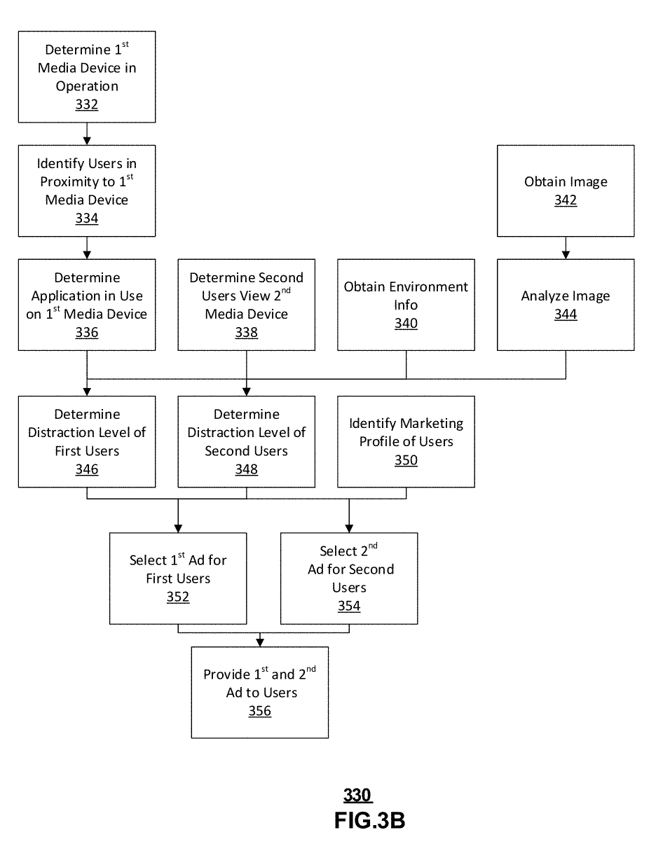

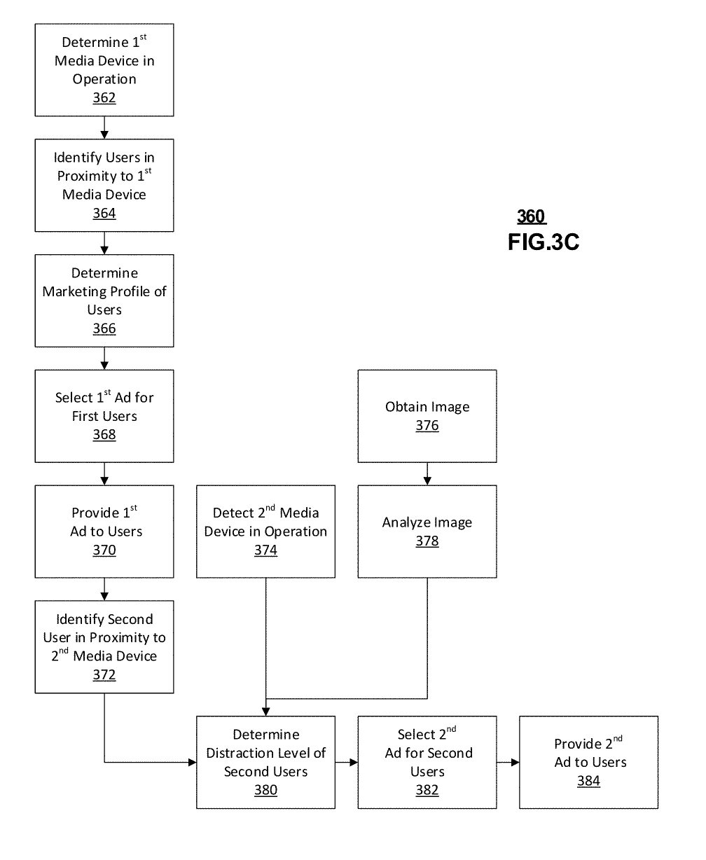

FIGS. 3A-3C depict illustrative embodiments of methods 300, 330, 360 used in portions of the system described in FIGS. 1A-1B and FIG. 2. The methods 300, 330, 360 can be implemented in part or in entirety by a gateway device, and advertisement management server or any other computing device.

Referring to FIG. 3A, method 300 can include the computing device, at 302, determining a media device at a customer premises is in operation. Further, the method 300 can include the computing device, at 304, identifying a user is in proximity to the media device. In addition, the method can include the computing device, at 306, obtaining environment information from one or more environment sensors. Also, the method 300 can include the computing device obtaining an image of the user, and, at 310, analyzing the image using image recognition techniques. Further, the method 300 can include the computing device, at 312, determining the media device type (i.e. the user is carrying a portable computing device/wearable device), and, at 314, identifying the media device (i.e. portable computing device/wearable device) is in motion.

In one or more embodiments, the method 300 can include the computing device, at 316, determining a distraction level for a user associated a media device. The distraction level can be a user distraction level or an environment distraction level. Also, the each of the user distraction level and the environment distraction level can comprise a visual distraction component and an audible distraction component. Further, it can determine a visual distraction component and/or an audible distraction component for each of the user distraction level or the environment distraction level. In some embodiments, the computing device can determine the distraction level for the user in response to determining a first application in use on the media device. In further embodiments, the distraction level is determined according to the environment information. The one or more environment sensors can include an ambient noise sensor and the environment information can include an ambient noise level. In other embodiments, determining the distraction level for the user comprises determining the user is looking away from the media device in response to analyzing the image using image recognition techniques.

In one or more embodiments, the method 300 can include the computing device, at 318, identifying a marketing profile for the user. Further, the method 300 can include the computing device, at 320, determining the first application in use visually obscures a second application that may provide a target advertisement. In addition, the method 300 can include a computing device, at 322, selecting a target advertisement according to the distraction level and the marketing profile. In some embodiments, the selecting of the target advertisement includes determining the ambient noise level is less than a predetermined threshold and the target advertisement includes visual media to attract user attention. In other embodiments in which the first application visually obscures the second application than may provide the target advertisement, the target advertisement includes audible media to attract user attention from the first application to view the target advertisement that is presented with the second application. In further embodiments in which it is determined that the user is looking away from the media device, the target advertisement includes audible media to attract user attention. In additional embodiments, the target advertisement includes audible media to attract user attention. Also, the method 300 can include the computing device, at 324, providing the target advertisement to be presented on the media device.

Referring to FIG. 3B, the method 330 can include a computing device, at 332, determining a first media device is in operation. Further, the method 330 can include, at 334, identifying a plurality of users is in proximity to the first media device. In addition, the method 330 can include the computing device, at 336, determining a first application in use on the first media device. The plurality of users comprise the first group of users. Also, the method 330 can include the computing device, at 338, determining the second group of users viewing a second media device. The plurality of users comprise the second group of users. Further, the method 330 can include the computing device, at 340, obtaining environment information from one or more environment sensors. In addition, the method 330 can include the computing device, at 342, obtaining an image of a viewing area of the first media device, and, at 344, analyzing the image using image recognition techniques.

In one or more embodiments, the method 330 can include the computing device, at 346, determining a first distraction level for a first group of users, and, at 348, determining a second distraction level for a second group of users. In some embodiments, both the first distraction level and the second distraction level can include a user distraction level and an environment distraction level. In further embodiments, each of the user distraction level and the environment distraction level can include a visual distraction component and an audible distraction component. In other embodiments, determining the first distraction level for the first group of users can be in response to determining the first application in use on the first media device. In additional embodiments, determining the second distraction level can be in response to determining the second group of users viewing a second media device. In some embodiments, determining the first distraction level can according to the environment information. In further embodiments, determining of the first distraction level can comprise determining the first group of users are viewing the first media device in response to analyzing the image using image recognition techniques.

In one or more embodiments, the method 330 can include the computing device, at 350, identifying a marketing profile for each user the plurality of users. Further, the method 330 can include the computing device, at 352, selecting a first target advertisement according to the first distraction level and a first marketing profile for each of the first group of users. In some embodiments, selecting of the first target advertisement includes determining the ambient noise level from an ambient noise sensor (which is one of the environment sensors) is less than a predetermined threshold. The first target advertisement includes visual media to attract user attention.

In one or more embodiments, the method 330 can include the computing device, at 354, selecting a second target advertisement according to the second distraction level and a second marketing profile for each of the second group of users. In some embodiments, it can be determined by the computing device that the second application in use visually obscures a third application providing the second target advertisement and the second target advertisement is selected to include audible media to attract user attention from the second application to view the target advertisement presented with the third application. Further, the method 330 can include the computing device, at 356, providing the first target advertisement to be presented on the first media device, and providing the second target advertisement to be presented on the second media device.

Referring FIG. 3C, the method 360 can include a computing device, at 360, at 362, determining a first media device is in operation. Further, the method 360 can include the computing device, at 364, identifying a plurality of users is in proximity to the first media device. In addition, the method 360 can include the computing device, at 366, determining a marketing profile for each user the plurality of users. Also, the method 360 can include the computing device, at 368, selecting a first target advertisement according to a first marketing profile for each of a first group of users and a second marketing profile for each of a second group of users. The plurality of users comprise the first group of users and the second group of users. The first target advertisement is selected to attract attention of each of the first group of users, and the first target advertisement is selected to distract attention of each of the second group of users. Further, the method 360 can include the computing device, at 370, providing, by the processing system, the first target advertisement to be presented on the first media device.

In one or more embodiments, the method 360 can include the computing device, at 372, identifying, by the processing system, the second group of users are in proximity to a second media device. Further, the method 360 can include the computing device, at 376, obtaining an image of a viewing area of the first media device, and, at 378, analyzing the image using image recognition techniques. In addition, the method 360 can include the computing device, at 380, determining a distraction level of each of the second group of users. In some embodiments, determining of the distraction level of each of the second group of users comprises detecting the second media device is in operation. In other embodiments, determining of the distraction level of each of the second group of users comprises determining the second group of users are not viewing the first media device in response to analyzing the image using image recognition techniques. Note, each distraction level can include a user distraction level and/or an environment distraction level. Further, each of the user distraction level and the environment distraction level can comprise a visual distraction component and an audible distraction component.

In one or more embodiments, the method 360 can include the computing device, at 382, selecting a second target advertisement according to the second marketing profile for each of the second group of users. In some embodiments, the selecting of the second target advertisement comprises selecting of the second target advertisement in response to determining a distraction level of each of the second group of users. Further, the method 360 can include the computing device, at 384, providing the second target advertisement to be presented on the second media device.

While for purposes of simplicity of explanation, the respective processes are shown and described as a series of blocks in FIG. 3, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Further, it is to be understood that any embodiments or portions thereof, can be combined with any other embodiments or portions thereof.

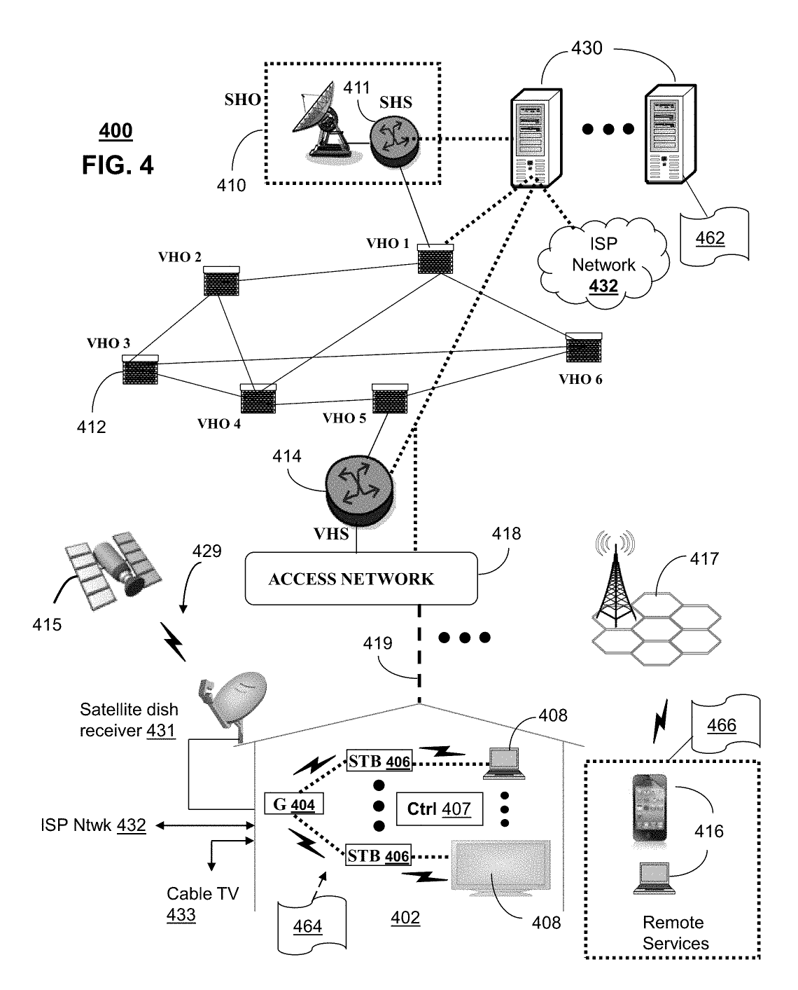

FIG. 4 depicts an illustrative embodiment of a communication system 400 for providing various communication services, such as delivering media content. The communication system 400 can represent an interactive media network, such as an interactive television system (e.g., an Internet Protocol Television (IPTV) media system). Communication system 400 can be overlaid or operably coupled with systems 100, 130, 200 of FIGS. 1 and/or 2 as another representative embodiment of communication system 400. For instance, one or more devices illustrated in the communication system 400 of FIG. 4 can include embodiments determining a media device is in operation and identifying a user is in proximity to the media device. Further embodiments can include determining a distraction level for the user in response to determining a first application in use on the media device. Additional embodiments can include identifying a marketing profile for the user. Also embodiments can include selecting a target advertisement according to the distraction level and the marketing profile. Further embodiments can include providing the target advertisement to be presented on the media device.

In one or more embodiments, the communication system 400 can include a super head-end office (SHO) 410 with at least one super headend office server (SHS) 411 which receives media content from satellite and/or terrestrial communication systems. In the present context, media content can represent, for example, audio content, moving image content such as 2D or 3D videos, video games, virtual reality content, still image content, and combinations thereof. The SHS server 411 can forward packets associated with the media content to one or more video head-end servers (VHS) 414 via a network of video head-end offices (VHO) 412 according to a multicast communication protocol. The VHS 414 can distribute multimedia broadcast content via an access network 418 to commercial and/or residential buildings 402 housing a gateway 404 (such as a residential or commercial gateway).

The access network 418 can represent a group of digital subscriber line access multiplexers (DSLAMs) located in a central office or a service area interface that provide broadband services over fiber optical links or copper twisted pairs 419 to buildings 402. The gateway 404 can use communication technology to distribute broadcast signals to media processors 406 such as Set-Top Boxes (STBs) which in turn present broadcast channels to media devices 408 such as computers or television sets managed in some instances by a media controller 407 (such as an infrared or RF remote controller).

The gateway 404, the media processors 406, and media devices 408 can utilize tethered communication technologies (such as coaxial, powerline or phone line wiring) or can operate over a wireless access protocol such as Wireless Fidelity (WiFi), Bluetooth®, Zigbee or other present or next generation local or personal area wireless network technologies. By way of these interfaces, unicast communications can also be invoked between the media processors 406 and subsystems of the IPTV media system for services such as video-on-demand (VoD), browsing an electronic programming guide (EPG), or other infrastructure services.

A satellite broadcast television system 429 can be used in the media system of FIG. 4. The satellite broadcast television system can be overlaid, operably coupled with, or replace the IPTV system as another representative embodiment of communication system 400. In this embodiment, signals transmitted by a satellite 415 that include media content can be received by a satellite dish receiver 431 coupled to the building 402. Modulated signals received by the satellite dish receiver 431 can be transferred to the media processors 406 for demodulating, decoding, encoding, and/or distributing broadcast channels to the media devices 408. The media processors 406 can be equipped with a broadband port to an Internet Service Provider (ISP) network 432 to enable interactive services such as VoD and EPG as described above.

In yet another embodiment, an analog or digital cable broadcast distribution system such as cable TV system 433 can be overlaid, operably coupled with, or replace the IPTV system and/or the satellite TV system as another representative embodiment of communication system 400. In this embodiment, the cable TV system 433 can also provide Internet, telephony, and interactive media services. System 400 enables various types of interactive television and/or services including IPTV, cable and/or satellite.

The subject disclosure can apply to other present or next generation over-the-air and/or landline media content services system.

Some of the network elements of the IPTV media system can be coupled to one or more computing devices 430, a portion of which can operate as a web server for providing web portal services over the ISP network 432 to wireline media devices 408 or wireless communication devices 416.

Communication system 400 can also provide for all or a portion of the computing devices 430 to function as an advertisement management server (herein referred to as advertisement management server 430). The advertisement management server 430 can use computing and communication technology to perform function 462, which can include among other things, the techniques described by method 300, 330, 360 of FIGS. 3A, 3B, 3C. For instance, function 462 of server 430 can be similar to the functions described for gateway device 122 and advertisement management server 132 of FIGS. 1A, 1B, and 1C in accordance with methods 300, 330, 360. The media processors 406 and wireless communication devices 416 can be provisioned with software functions 464 and 466, respectively, to utilize the services of advertisement management server 430. For instance, functions 464 and 466 of media processors 406 and wireless communication devices 416 can be similar to the functions described for the communication devices 102, 108, 112, 120, 124 of FIG. 1A in accordance with methods 300, 330, 360.

Multiple forms of media services can be offered to media devices over landline technologies such as those described above. Additionally, media services can be offered to media devices by way of a wireless access base station 417 operating according to common wireless access protocols such as Global System for Mobile or GSM, Code Division Multiple Access or CDMA, Time Division Multiple Access or TDMA, Universal Mobile Telecommunications or UMTS, World interoperability for Microwave or WiMAX, Software Defined Radio or SDR, Long Term Evolution or LTE, and so on. Other present and next generation wide area wireless access network technologies can be used in one or more embodiments of the subject disclosure.

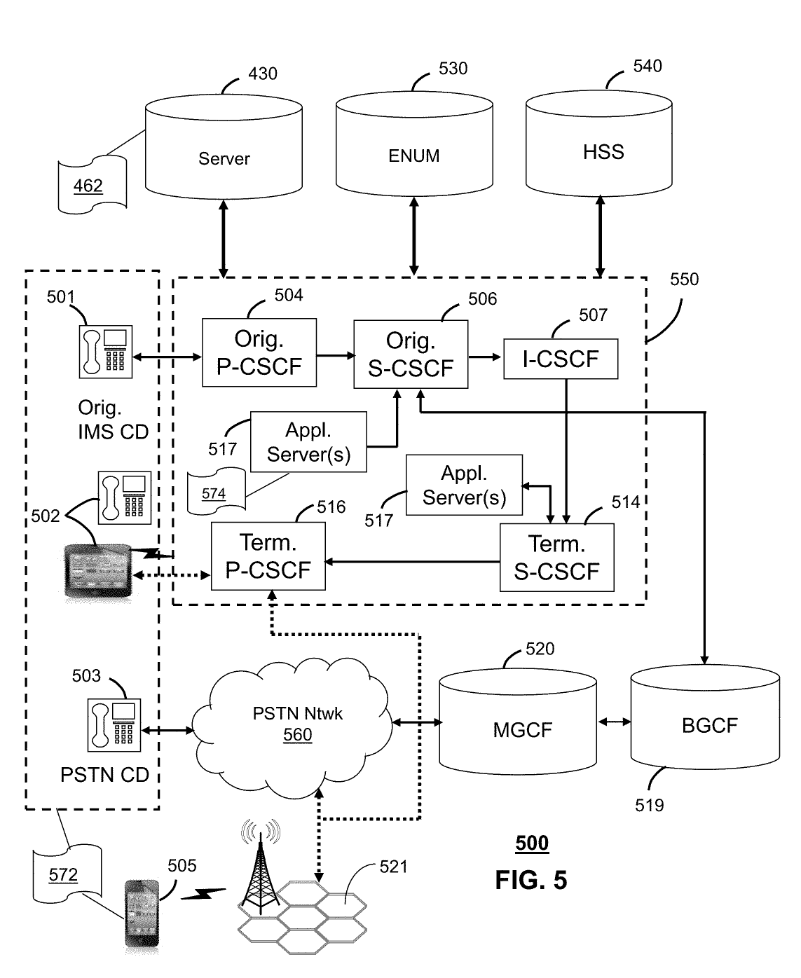

FIG. 5 depicts an illustrative embodiment of a communication system 500 employing an IP Multimedia Subsystem (IMS) network architecture to facilitate the combined services of circuit-switched and packet-switched systems. Communication system 500 can be overlaid or operably coupled with systems 100, 130, 200 of FIGS. 1A, 1B and/or 2 and communication system 400 as another representative embodiment of communication system 400. Embodiments can include determining a first media device is in operation and identifying a plurality of users is in proximity to the first media device. Further embodiments can include determining a first distraction level for a first group of users in response to determining a first application in use on the first media device. The plurality of users comprise the first group of users. Additional embodiments can include determining a second distraction level for a second group of users in response to determining the second group of users viewing a second media device. The plurality of users comprise the second group of users. Also, embodiments can include identifying a marketing profile for each user the plurality of users. Further embodiments can include selecting a first target advertisement according to the first distraction level and a first marketing profile for each of the first group of users. Additional embodiments can include selecting a second target advertisement according to the second distraction level and a second marketing profile for each of the second group of users. Also, embodiments can include providing the first target advertisement to be presented on the first media device, and providing the second target advertisement to be presented on the second media device.

Communication system 500 can comprise a Home Subscriber Server (HSS) 540, a tElephone NUmber Mapping (ENUM) server 530, and other network elements of an IMS network 550. The IMS network 550 can establish communications between IMS-compliant communication devices (CDs) 501, 502, Public Switched Telephone Network (PSTN) CDs 503, 505, and combinations thereof by way of a Media Gateway Control Function (MGCF) 520 coupled to a PSTN network 560. The MGCF 520 need not be used when a communication session involves IMS CD to IMS CD communications. A communication session involving at least one PSTN CD may utilize the MGCF 520.

IMS CDs 501, 502 can register with the IMS network 550 by contacting a Proxy Call Session Control Function (P-CSCF) which communicates with an interrogating CSCF (I-CSCF), which in turn, communicates with a Serving CSCF (S-CSCF) to register the CDs with the HSS 540. To initiate a communication session between CDs, an originating IMS CD 501 can submit a Session Initiation Protocol (SIP INVITE) message to an originating P-CSCF 504 which communicates with a corresponding originating S-CSCF 506. The originating S-CSCF 506 can submit the SIP INVITE message to one or more application servers (ASs) 517 that can provide a variety of services to IMS subscribers.

For example, the application servers 517 can be used to perform originating call feature treatment functions on the calling party number received by the originating S-CSCF 506 in the SIP INVITE message. Originating treatment functions can include determining whether the calling party number has international calling services, call ID blocking, calling name blocking, 7-digit dialing, and/or is requesting special telephony features (e.g., *72 forward calls, *73 cancel call forwarding, *67 for caller ID blocking, and so on). Based on initial filter criteria (iFCs) in a subscriber profile associated with a CD, one or more application servers may be invoked to provide various call originating feature services.

Additionally, the originating S-CSCF 506 can submit queries to the ENUM system 530 to translate an E.164 telephone number in the SIP INVITE message to a SIP Uniform Resource Identifier (URI) if the terminating communication device is IMS-compliant. The SIP URI can be used by an Interrogating CSCF (I-CSCF) 507 to submit a query to the HSS 540 to identify a terminating S-CSCF 514 associated with a terminating IMS CD such as reference 502. Once identified, the I-CSCF 507 can submit the SIP INVITE message to the terminating S-CSCF 514. The terminating S-CSCF 514 can then identify a terminating P-CSCF 516 associated with the terminating CD 502. The P-CSCF 516 may then signal the CD 502 to establish Voice over Internet Protocol (VoIP) communication services, thereby enabling the calling and called parties to engage in voice and/or data communications. Based on the iFCs in the subscriber profile, one or more application servers may be invoked to provide various call terminating feature services, such as call forwarding, do not disturb, music tones, simultaneous ringing, sequential ringing, etc.

In some instances the aforementioned communication process is symmetrical. Accordingly, the terms “originating” and “terminating” in FIG. 5 may be interchangeable. It is further noted that communication system 500 can be adapted to support video conferencing. In addition, communication system 500 can be adapted to provide the IMS CDs 501, 502 with the multimedia and Internet services of communication system 400 of FIG. 4.

If the terminating communication device is instead a PSTN CD such as CD 503 or CD 505 (in instances where the cellular phone only supports circuit-switched voice communications), the ENUM system 530 can respond with an unsuccessful address resolution which can cause the originating S-CSCF 506 to forward the call to the MGCF 520 via a Breakout Gateway Control Function (BGCF) 519. The MGCF 520 can then initiate the call to the terminating PSTN CD over the PSTN network 560 to enable the calling and called parties to engage in voice and/or data communications.

It is further appreciated that the CDs of FIG. 5 can operate as wireline or wireless devices. For example, the CDs of FIG. 5 can be communicatively coupled to a cellular base station 521, a femtocell, a WiFi router, a Digital Enhanced Cordless Telecommunications (DECT) base unit, or another suitable wireless access unit to establish communications with the IMS network 550 of FIG. 5. The cellular access base station 521 can operate according to common wireless access protocols such as GSM, CDMA, TDMA, UMTS, WiMax, SDR, LTE, and so on. Other present and next generation wireless network technologies can be used by one or more embodiments of the subject disclosure. Accordingly, multiple wireline and wireless communication technologies can be used by the CDs of FIG. 5.

Cellular phones supporting LTE can support packet-switched voice and packet-switched data communications and thus may operate as IMS-compliant mobile devices. In this embodiment, the cellular base station 521 may communicate directly with the IMS network 550 as shown by the arrow connecting the cellular base station 521 and the P-CSCF 516.

Alternative forms of a CSCF can operate in a device, system, component, or other form of centralized or distributed hardware and/or software. Indeed, a respective CSCF may be embodied as a respective CSCF system having one or more computers or servers, either centralized or distributed, where each computer or server may be configured to perform or provide, in whole or in part, any method, step, or functionality described herein in accordance with a respective CSCF. Likewise, other functions, servers and computers described herein, including but not limited to, the HSS, the ENUM server, the BGCF, and the MGCF, can be embodied in a respective system having one or more computers or servers, either centralized or distributed, where each computer or server may be configured to perform or provide, in whole or in part, any method, step, or functionality described herein in accordance with a respective function, server, or computer.

The advertisement management server 430 of FIG. 4 can be operably coupled to communication system 500 for purposes similar to those described above. Advertisement management server can perform function 462 and thereby provide advertisement management services to the CDs 501, 502, 503 and 505 of FIG. 5 similar to the functions described for gateway device 122 and advertisement management server 132 of FIGS. 1A, 1B, and FIG. 2 in accordance with methods 300, 330, 360 of FIGS. 3A, 3B, and 3C. CDs 501, 502, 503 and 505, which can be adapted with software to perform function 572 to utilize the services of the advertisement management server 430 similar to the functions described for communication devices 102, 108, 112, 120, 124 of FIG. 1A in accordance with methods 300, 330, 360 of FIGS. 3A, 3B, 3C. Advertisement management server 430 can be an integral part of the application server(s) 517 performing function 574, which can be substantially similar to function 462 and adapted to the operations of the IMS network 550.

For illustration purposes only, the terms S-CSCF, P-CSCF, I-CSCF, and so on, can be server devices, but may be referred to in the subject disclosure without the word “server.” It is also understood that any form of a CSCF server can operate in a device, system, component, or other form of centralized or distributed hardware and software. It is further noted that these terms and other terms such as DIAMETER commands are terms can include features, methodologies, and/or fields that may be described in whole or in part by standards bodies such as 3^{rd} Generation Partnership Project (3GPP). It is further noted that some or all embodiments of the subject disclosure may in whole or in part modify, supplement, or otherwise supersede final or proposed standards published and promulgated by 3GPP.

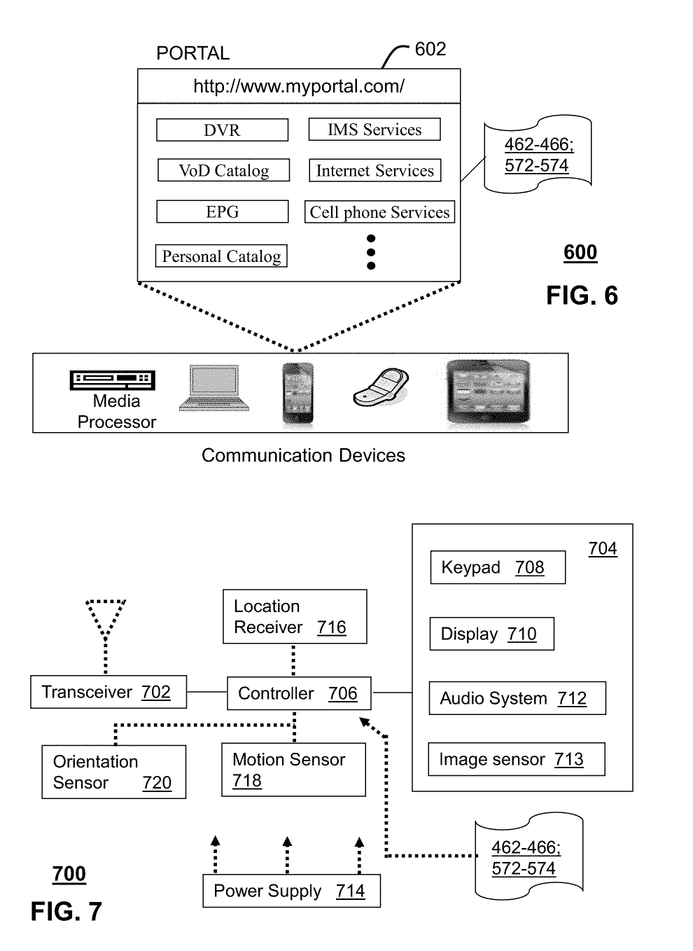

FIG. 6 depicts an illustrative embodiment of a web portal 602 of a communication system 600. Communication system 600 can be overlaid or operably coupled with systems 100, 130, 200 of FIGS. 1A, 1B and/or 2, communication system 400, and/or communication system 500 as another representative embodiment of systems 100, 130, 200 of FIGS. 1A, 1B and/or 2, communication system 400, and/or communication system 500. The web portal 602 can be used for managing services of systems 100, 130, 200 of FIGS. 1A, 1B and/or 2 and communication systems 400-500. A web page of the web portal 602 can be accessed by a Uniform Resource Locator (URL) with an Internet browser using an Internet-capable communication device such as those described in FIGS. 1A, 1B and/or 2 and FIGS. 4-5. The web portal 602 can be configured, for example, to access a media processor 406 and services managed thereby such as a Digital Video Recorder (DVR), a Video on Demand (VoD) catalog, an Electronic Programming Guide (EPG), or a personal catalog (such as personal videos, pictures, audio recordings, etc.) stored at the media processor 406. The web portal 602 can also be used for provisioning IMS services described earlier, provisioning Internet services, provisioning cellular phone services, and so on.

The web portal 602 can further be utilized to manage and provision software applications 462-466, and 572-574 to adapt these applications as may be desired by subscribers and/or service providers of systems 100, 130 of FIGS. 1A, 1B and/or 2, and communication systems 400-500. For instance, users of the services provided by gateway device 122, advertisement management server 132, 430 can log into their on-line accounts and provision the gateway device 122, advertisement management server 132, 430 with, for example, predetermined thresholds for distraction levels as described herein and associating advertisements with distraction levels or range of distraction levels. Service providers can log onto an administrator account to provision, monitor and/or maintain the systems 100, 130, 200 of FIGS. 1A, 1B and/or 2 or server 430.

FIG. 7 depicts an illustrative embodiment of a communication device 700. Communication device 700 can serve in whole or in part as an illustrative embodiment of the devices depicted in FIGS. 1A, 1B and/or 2, and FIGS. 4-5 and can be configured to perform portions of methods 300, 330, 360 of FIG. 3.

Communication device 700 can comprise a wireline and/or wireless transceiver 702 (herein transceiver 702), a user interface (UI) 704, a power supply 714, a location receiver 716, a motion sensor 718, an orientation sensor 720, and a controller 706 for managing operations thereof. The transceiver 702 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 702 can also be adapted to support circuit-switched wireline access technologies (such as PSTN), packet-switched wireline access technologies (such as TCP/IP, VoIP, etc.), and combinations thereof.

The UI 704 can include a depressible or touch-sensitive keypad 708 with a navigation mechanism such as a roller ball, a joystick, a mouse, or a navigation disk for manipulating operations of the communication device 700. The keypad 708 can be an integral part of a housing assembly of the communication device 700 or an independent device operably coupled thereto by a tethered wireline interface (such as a USB cable) or a wireless interface supporting for example Bluetooth®. The keypad 708 can represent a numeric keypad commonly used by phones, and/or a QWERTY keypad with alphanumeric keys. The UI 704 can further include a display 710 such as monochrome or color LCD (Liquid Crystal Display), OLED (Organic Light Emitting Diode) or other suitable display technology for conveying images to an end user of the communication device 700. In an embodiment where the display 710 is touch-sensitive, a portion or all of the keypad 708 can be presented by way of the display 710 with navigation features.

The display 710 can use touch screen technology to also serve as a user interface for detecting user input. As a touch screen display, the communication device 700 can be adapted to present a user interface with graphical user interface (GUI) elements that can be selected by a user with a touch of a finger. The touch screen display 710 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 710 can be an integral part of the housing assembly of the communication device 700 or an independent device communicatively coupled thereto by a tethered wireline interface (such as a cable) or a wireless interface.

The UI 704 can also include an audio system 712 that utilizes audio technology for conveying low volume audio (such as audio heard in proximity of a human ear) and high volume audio (such as speakerphone for hands free operation). The audio system 712 can further include a microphone for receiving audible signals of an end user. The audio system 712 can also be used for voice recognition applications. The UI 704 can further include an image sensor 713 such as a charged coupled device (CCD) camera for capturing still or moving images.

The power supply 714 can utilize common power management technologies such as replaceable and rechargeable batteries, supply regulation technologies, and/or charging system technologies for supplying energy to the components of the communication device 700 to facilitate long-range or short-range portable applications. Alternatively, or in combination, the charging system can utilize external power sources such as DC power supplied over a physical interface such as a USB port or other suitable tethering technologies.

The location receiver 716 can utilize location technology such as a global positioning system (GPS) receiver capable of assisted GPS for identifying a location of the communication device 700 based on signals generated by a constellation of GPS satellites, which can be used for facilitating location services such as navigation. The motion sensor 718 can utilize motion sensing technology such as an accelerometer, a gyroscope, or other suitable motion sensing technology to detect motion of the communication device 700 in three-dimensional space. The orientation sensor 720 can utilize orientation sensing technology such as a magnetometer to detect the orientation of the communication device 700 (north, south, west, and east, as well as combined orientations in degrees, minutes, or other suitable orientation metrics).

The communication device 700 can use the transceiver 702 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 706 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 700.

Other components not shown in FIG. 7 can be used in one or more embodiments of the subject disclosure. For instance, the communication device 700 can include a reset button (not shown). The reset button can be used to reset the controller 706 of the communication device 700. In yet another embodiment, the communication device 700 can also include a factory default setting button positioned, for example, below a small hole in a housing assembly of the communication device 700 to force the communication device 700 to re-establish factory settings. In this embodiment, a user can use a protruding object such as a pen or paper clip tip to reach into the hole and depress the default setting button. The communication device 700 can also include a slot for adding or removing an identity module such as a Subscriber Identity Module (SIM) card. SIM cards can be used for identifying subscriber services, executing programs, storing subscriber data, and so forth.

The communication device 700 as described herein can operate with more or less of the circuit components shown in FIG. 7. These variant embodiments can be used in one or more embodiments of the subject disclosure.

The communication device 700 can be adapted to perform the functions of devices of FIGS. 1A, 1B and/or 2, the media processor 406, the media devices 408, or the portable communication devices 416 of FIG. 4, as well as the IMS CDs 501-502 and PSTN CDs 503-505 of FIG. 5. It will be appreciated that the communication device 700 can also represent other devices that can operate in systems 100, 130, 200 of FIGS. 1 and/or 2, communication systems 400-500 of FIGS. 4-5 such as a gaming console and a media player. In addition, the controller 706 can be adapted in various embodiments to perform the functions 462-466 and 572-574, respectively.

Upon reviewing the aforementioned embodiments, it would be evident to an artisan with ordinary skill in the art that said embodiments can be modified, reduced, or enhanced without departing from the scope of the claims described below. Other embodiments can be used in the subject disclosure.

It should be understood that devices described in the exemplary embodiments can be in communication with each other via various wireless and/or wired methodologies. The methodologies can be links that are described as coupled, connected and so forth, which can include unidirectional and/or bidirectional communication over wireless paths and/or wired paths that utilize one or more of various protocols or methodologies, where the coupling and/or connection can be direct (e.g., no intervening processing device) and/or indirect (e.g., an intermediary processing device such as a router).

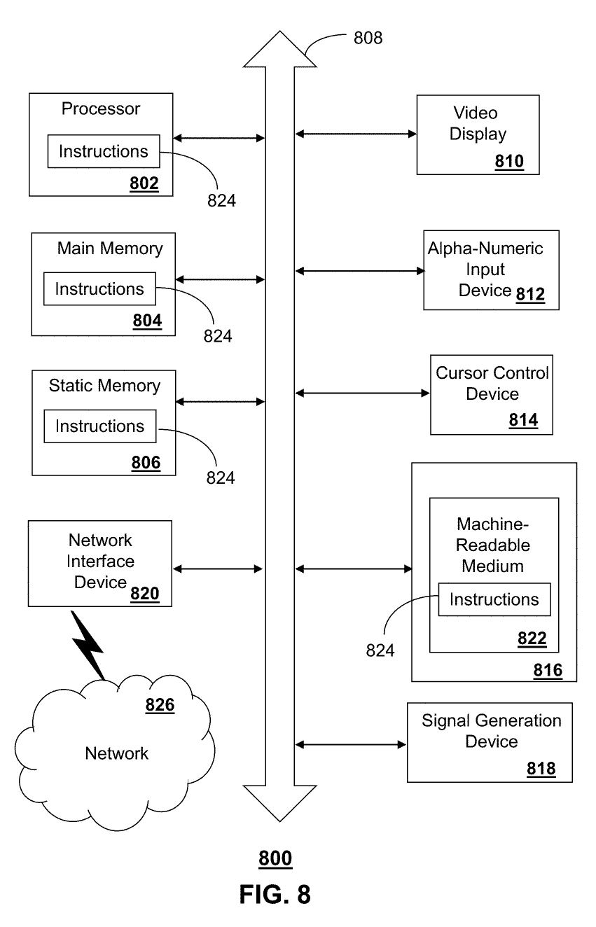

FIG. 8 depicts an exemplary diagrammatic representation of a machine in the form of a computer system 800 within which a set of instructions, when executed, may cause the machine to perform any one or more of the methods described above. One or more instances of the machine can operate, for example, as the advertisement management server 430, the media processor 406, 102, 108, 112, 120, 122, 124, 132 and other devices of FIGS. 1-5. In some embodiments, the machine may be connected (e.g., using a network 826) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

The computer system 800 may include a processor (or controller) 802 (e.g., a central processing unit (CPU)), a graphics processing unit (GPU, or both), a main memory 804 and a static memory 806, which communicate with each other via a bus 808. The computer system 800 may further include a display unit 810 (e.g., a liquid crystal display (LCD), a flat panel, or a solid state display). The computer system 800 may include an input device 812 (e.g., a keyboard), a cursor control device 814 (e.g., a mouse), a disk drive unit 816, a signal generation device 818 (e.g., a speaker or remote control) and a network interface device 820. In distributed environments, the embodiments described in the subject disclosure can be adapted to utilize multiple display units 810 controlled by two or more computer systems 800. In this configuration, presentations described by the subject disclosure may in part be shown in a first of the display units 810, while the remaining portion is presented in a second of the display units 810.

The disk drive unit 816 may include a tangible computer-readable storage medium 822 on which is stored one or more sets of instructions (e.g., software 824) embodying any one or more of the methods or functions described herein, including those methods illustrated above. The instructions 824 may also reside, completely or at least partially, within the main memory 804, the static memory 806, and/or within the processor 802 during execution thereof by the computer system 800. The main memory 804 and the processor 802 also may constitute tangible computer-readable storage media.

Dedicated hardware implementations including, but not limited to, application specific integrated circuits, programmable logic arrays and other hardware devices can likewise be constructed to implement the methods described herein. Application specific integrated circuits and programmable logic array can use downloadable instructions for executing state machines and/or circuit configurations to implement embodiments of the subject disclosure. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the subject disclosure, the operations or methods described herein are intended for operation as software programs or instructions running on or executed by a computer processor or other computing device, and which may include other forms of instructions manifested as a state machine implemented with logic components in an application specific integrated circuit or field programmable gate array. Furthermore, software implementations (e.g., software programs, instructions, etc.) including, but not limited to, distributed processing or component/object distributed processing, parallel processing, or virtual machine processing can also be constructed to implement the methods described herein. Distributed processing environments can include multiple processors in a single machine, single processors in multiple machines, and/or multiple processors in multiple machines. It is further noted that a computing device such as a processor, a controller, a state machine or other suitable device for executing instructions to perform operations or methods may perform such operations directly or indirectly by way of one or more intermediate devices directed by the computing device.

While the tangible computer-readable storage medium 822 is shown in an example embodiment to be a single medium, the term “tangible computer-readable storage medium” should be taken to include a single medium or multiple media (e.g., a centralized or distributed database, and/or associated caches and servers) that store the one or more sets of instructions. The term “tangible computer-readable storage medium” shall also be taken to include any non-transitory medium that is capable of storing or encoding a set of instructions for execution by the machine and that cause the machine to perform any one or more of the methods of the subject disclosure. The term “non-transitory” as in a non-transitory computer-readable storage includes without limitation memories, drives, devices and anything tangible but not a signal per se.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are from time-to-time superseded by faster or more efficient equivalents having essentially the same functions. Wireless standards for device detection (e.g., RFID), short-range communications (e.g., Bluetooth®, WiFi, Zigbee®), and long-range communications (e.g., WiMAX, GSM, CDMA, LTE) can be used by computer system 800. In one or more embodiments, information regarding use of services can be generated including services being accessed, media consumption history, user preferences, and so forth. This information can be obtained by various methods including user input, detecting types of communications (e.g., video content vs. audio content), analysis of content streams, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. The exemplary embodiments can include combinations of features and/or steps from multiple embodiments. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized Accordingly, the specification and drawings are to be regarded in an illustrative rather than a restrictive sense.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

Less than all of the steps or functions described with respect to the exemplary processes or methods can also be performed in one or more of the exemplary embodiments. Further, the use of numerical terms to describe a device, component, step or function, such as first, second, third, and so forth, is not intended to describe an order or function unless expressly stated so. The use of the terms first, second, third and so forth, is generally to distinguish between devices, components, steps or functions unless expressly stated otherwise. Additionally, one or more devices or components described with respect to the exemplary embodiments can facilitate one or more functions, where the facilitating (e.g., facilitating access or facilitating establishing a connection) can include less than every step needed to perform the function or can include all of the steps needed to perform the function.

In one or more embodiments, a processor (which can include a controller or circuit) has been described that performs various functions. It should be understood that the processor can be multiple processors, which can include distributed processors or parallel processors in a single machine or multiple machines. The processor can be used in supporting a virtual processing environment. The virtual processing environment may support one or more virtual machines representing computers, servers, or other computing devices. In such virtual machines, components such as microprocessors and storage devices may be virtualized or logically represented. The processor can include a state machine, application specific integrated circuit, and/or programmable gate array including a Field PGA. In one or more embodiments, when a processor executes instructions to perform “operations”, this can include the processor performing the operations directly and/or facilitating, directing, or cooperating with another device or component to perform the operations.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A device, comprising:
a processing system including a processor; and
a memory that stores executable instructions that, when executed by the processing system, facilitate performance of operations, the operations comprising:
determining a media device is in operation;
identifying that a user is in proximity to the media device;
determining a distraction level for the user in response to determining a first application in use on the media device;
identifying a marketing profile for the user;
selecting a target advertisement according to the distraction level and the marketing profile; and
providing the target advertisement to be presented on the media device.

2. The device of claim 1, wherein the determining the distraction level comprises obtaining environment information from an environment sensor, and wherein the determining of the distraction level comprises determining the distraction level according to the environment information.

3. The device of claim 2, wherein the environment sensor includes an ambient noise sensor, wherein the environment information includes an ambient noise level, wherein the selecting of the target advertisement includes determining the ambient noise level is less than a predetermined threshold, and wherein the target advertisement includes visual media to attract user attention.

4. The device of claim 1, wherein the operations comprise determining the first application in use visually obscures a second application providing the target advertisement, and wherein the target advertisement includes audible media to attract user attention.

5. The device of claim 1, wherein the operations comprise obtaining an image of the user, wherein the determining the distraction level for the user comprises determining the user is looking away from the media device in response to analyzing the image using image recognition techniques, and wherein the target advertisement includes audible media to attract user attention.

6. The device of claim 1, wherein the operations comprise:
determining the user is carrying a portable computing device; and
identifying that the portable computing device is in motion.

7. The device of claim 6, wherein the target advertisement includes audible media to attract user attention.

8. The device of claim 6, wherein the target advertisement includes visual media to attract user attention.

9. A machine-readable medium, comprising executable instructions that, when executed by a processing system including a processor, facilitate performance of operations, the operations comprising:
determining a first media device is in operation;
identifying that a plurality of users is in proximity to the first media device;
determining a first distraction level for a first group of users in response to determining a first application in use on the first media device, wherein the plurality of users comprise the first group of users;
determining a second distraction level for a second group of users in response to determining the second group of users viewing a second media device, wherein the plurality of users comprise the second group of users;
identifying a marketing profile for each user the plurality of users;
selecting a first target advertisement according to the first distraction level and a first marketing profile for each of the first group of users;
selecting a second target advertisement according to the second distraction level and a second marketing profile for each of the second group of users; and
providing the first target advertisement to be presented on the first media device, and providing the second target advertisement to be presented on the second media device.

10. The machine-readable medium of claim 9, wherein the first media device is a television and the second media device is a portable computing device.

11. The machine-readable medium of claim 9, wherein the determining the first distraction level comprises obtaining environment information from an environment sensor, and wherein the determining the first distraction level comprises determining the first distraction level according to the environment information.

12. The machine-readable medium of claim 11, wherein the environment sensor includes an ambient noise sensor, wherein the environment information includes an ambient noise level, wherein the selecting of the first target advertisement includes determining the ambient noise level is less than a predetermined threshold, and wherein the first target advertisement includes visual media to attract user attention.

13. The machine-readable medium of claim 9, wherein the operations comprise:
identifying a second application in use on the second media device; and
determining the second application in use visually obscures a third application providing the second target advertisement, wherein the second target advertisement includes audible media to attract user attention.

14. The machine-readable medium of claim 9, wherein the operations comprise obtaining an image of a viewing area of the first media device, wherein the determining of the first distraction level comprises determining the first group of users are viewing the first media device in response to analyzing the image using image recognition techniques.

15. The machine-readable medium of claim 9, wherein the operations comprise obtaining an image of a viewing area, wherein the determining of the second distraction level comprises determining the second group of users are viewing the second media device in response to analyzing the image using image recognition techniques.

16. A method, comprising:
determining, by a processing system including a processor, a first media device is in operation;
identifying, by the processing system, that a plurality of users is in proximity to the first media device;
determining, by the processing system, a marketing profile for each user the plurality of users;
selecting, by the processing system, a first target advertisement according to a first marketing profile for each of a first group of users and a second marketing profile for each of a second group of users, wherein the plurality of users comprise the first group of users and the second group of users, wherein the first target advertisement is selected to attract attention of each of the first group of users, and wherein the first target advertisement is selected to distract attention of each of the second group of users;
providing, by the processing system, the first target advertisement to be presented on the first media device;
identifying, by the processing system, that the second group of users are in proximity to a second media device;
selecting, by the processing system, a second target advertisement according to the second marketing profile for each of the second group of users; and
providing, by the processing system, the second target advertisement to be presented on the second media device.

17. The method of claim 16, wherein the first media device comprises a television and the second media device comprises a portable computing device.

18. The method of claim 16, wherein the selecting the second target advertisement comprises selecting of the second target advertisement in response to determining, by the processing system, a distraction level of each of the second group of users.

19. The method of claim 18, wherein the determining the distraction level of each of the second group of users comprises detecting, by the processing system, the second media device is in operation.

20. The method of claim 18, wherein the determining the distraction level of each of the second group of users comprises:
obtaining, by the processing system, an image of a viewing area of the first media device; and
determining, by the processing system, the second group of users are not viewing the first media device in response to analyzing the image using image recognition techniques.
